(19) United States
(12) Patent Application Publication
(10) Pub. No.: US 2014/0023332 A1
(43) Pub. Date: Jan. 23, 2014

(54) PLASTIC FIBER RIBBON AND COVER REMOVAL METHOD THEREOF

(71) Applicant: KABUSHIKI KAISHA TOSHIBA, Tokyo (JP)

(72) Inventors: Michihiko NISHIGAKI, Kanagawa (JP); Hideto FURUYAMA, Kanagawa (JP)

(73) Assignee: KABUSHIKI KAISHA TOSHIBA, Tokyo (JP)

(21) Appl. No.: 13/785,855

(22) Filed: Mar. 5, 2013

(30) Foreign Application Priority Data
Jul. 23, 2012 (JP) P2012-162706

(51) Int. Cl. G02B 6/44

(52) U.S. Cl. CPC G02B 6/4403; G02B 6/4498
USPC 385/114; 83/13

(57) ABSTRACT

A plastic fiber ribbon includes a plastic fiber, a buffer layer formed to surround an outer circumference of the plastic fiber, a spacer arranged substantially in parallel with the plastic fiber, and a cover part covering the plastic fiber, the buffer layer, and the spacer. A diameter L of the spacer is set to be larger than an inner diameter L1 of the buffer layer and smaller than an outer diameter L2 of the buffer layer, so that blades used to cut into the plastic fiber ribbon remain spaced from the plastic fiber by engaging the blades against the spacer.

### FIELD

Embodiments described herein relate to a plastic fiber ribbon and a cover removal method of the plastic fiber ribbon.

### BACKGROUND

When a fiber ribbon that a plurality of optical fibers is covered by a cover is attached to a connector or a ferrule, the cover of a ribbon tip needs to be removed with a remover and the like. Cover removal with a remover is performed by holding the ribbon on the front and back of a removal position, digging blades into the cover at the removal position, and sliding off the cover in the state in which the cover is cut.

In cover removal of a silica fiber ribbon, silica fibers are less likely to be damaged even when silica fibers contact a blade of a remover. Furthermore, a tensile strength of the silica fibers range several to several hundred N and is enough larger than a tensile force added during sliding off of a cover. Therefore, the silica fibers are rarely damaged even when a dig amount of the blade of the remover or the tensile force differs every time.

Meanwhile, in the case of a plastic fiber ribbon, a tensile strength of plastic fibers is smaller by a single digit or more in comparison with that of the silica fibers, and the plastic fibers may be stretched during cover removal with a remover. This becomes remarkable as a diameter of the plastic fibers becomes smaller. In the worst case, the plastic fiber ribbon may be cut.

Methods of removing a cover other than a method using a remover include a method using carbon dioxide laser or YAG laser, a method of carbonizing a cover by electric discharge machining, and a method of dissolving a cover with acid and the like. However, these methods may damage or dissolve the plastic fibers.

### PRIOR ART

### Patent Application Publication

JPA2007-199419

### GENERAL DESCRIPTION OF INVENTION

### Problem that the Invention is Directed to Solve

The problem that this invention is directed to solve is to provide a highly reliable plastic fiber ribbon and a cover removal method suppress stretch, cut, damage, and the like of the plastic fibers during cover removal.

### Solution to Solve the Problem

A plastic fiber ribbons disclosed in embodiments includes a plastic fiber, a buffer layer formed to surround an outer circumference of the plastic fiber, a spacer arranged substantially in parallel with the plastic fiber, and a cover part covering the plastic fiber, the buffer layer, and the spacer. A diameter L of the spacer is set to be larger than an inner diameter L1 of the buffer layer and smaller than an outer diameter L2 of the buffer layer.

### BRIEF DESCRIPTION OF THE DRAWINGS

FIG. 1 are a sectional view and a top plan view of a schematic configuration of a plastic fiber ribbon according to a first embodiment.

FIG. 2 are top plan views that illustrate steps of removing a tip part of the plastic fiber ribbon of FIG. 1.

FIG. 3 is a sectional view that illustrates the state in which blades of a remover dig into a cover of the plastic fiber ribbon of FIG. 1.

FIG. 4 is a sectional view of a schematic configuration of a plastic fiber ribbon according to a second embodiment.

FIG. 5 are sectional views that illustrate states in which blades of the remover dig into a cover of the plastic fiber ribbon, and explain effects of the second embodiment.

FIG. 6 are top plan views of a configuration in which the plastic fiber ribbon is installed to a ferrule, and explain the effects of the second embodiment.

FIG. 7 is a sectional view of a modification of the second embodiment.

FIG. 8 are sectional views of a schematic configuration of a plastic fiber ribbon according to a third embodiment.

FIG. 9 are sectional views of a schematic configuration of a plastic fiber ribbon according to a fourth embodiment.

FIG. 10 is a sectional view of a schematic configuration of a plastic fiber ribbon according to a fifth embodiment.

FIG. 11 are top plan views that illustrate steps of removing a tip part of the plastic fiber ribbon of FIG. 10.

FIG. 12 are, respectively, a sectional view and a top plan view of a schematic configuration of a plastic fiber ribbon according to a sixth embodiment.

FIG. 13 are top plan views that illustrate steps of removing a tip part of the plastic fiber ribbon of FIG. 12.

### EMBODIMENTS TO PRACTICE THE INVENTION

Hereinafter, plastic fiber ribbons and cover removal methods of embodiments will be described in detail with reference to the accompanying drawings.

In the following description of the drawings, the same or similar parts are denoted by like or similar reference numerals. However, it should be noted that the drawings are schematic, and the relationship between a thickness and planar dimensions, the proportion of the thickness of each layer, and the like are different from actual ones. Therefore, the specific thickness and dimensions should be determined by taking into consideration of the following explanation. Further, it is needless to say that parts having dimensional relationships and proportions that are different between the drawings are contained.

### First Embodiment

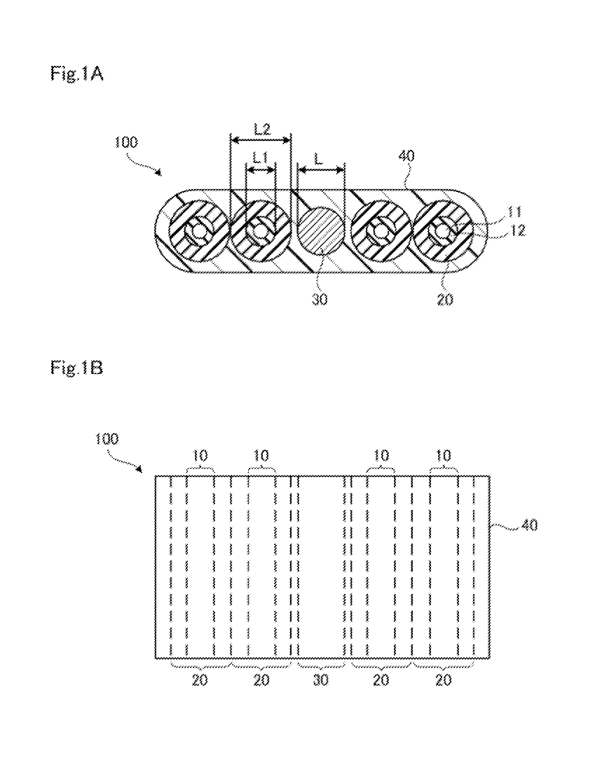

FIG. 1(a) is a sectional view of a schematic configuration of a plastic fiber ribbon 100 according to a first embodiment. FIG. 1(b) is a top plan view of the schematic configuration of the plastic fiber ribbon 100 according to the first embodiment.

The plastic fiber ribbon 100 according to the present embodiment is configured from plastic fibers 10 including a core 11 and a cladding 12 for which a plastic material is used, buffer layers 20, a spacer 30, and a cover part 40.

As a specific configuration, the buffer layer 20 is coaxially formed to cover the circumference of the plastic fiber 10, and a plurality of (for example, 4) plastic fibers 10 with the buffer layers 20 are arranged in parallel. Furthermore, one spacer 30 is formed in parallel with the plastic fibers 10. The plastic fibers 10 and the spacer 30 are arranged at the same interval, and the spacer 30 is arranged at the center of an alignment of the plastic fibers 10. Then, the cover part 40 is formed to cover the buffer layers 20 and the spacer 30, that is, they are arranged to form a ribbon-shaped multicore optical fiber.

The plastic fiber 10 is a graded-index fiber formed of fluorine-based resin, for example. However, the material thereof may be made of polymethyl methacrylate (PMMA) resin and polycarbonate resin, and a step-index fiber may be used.

The buffer layer 20 is for arranging the plastic fibers 10 at the same predetermined interval, and is formed of a material with lower Young's modulus (or being softer) than the cover part 40 and a low adherence force to the plastic fiber 10 than the cover part 40. By selecting such a material, the cover part 40 is removable from the plastic fibers 10 with a low tensile force. Accordingly, suppression of stretch of the plastic fibers 10 during removal is possible. As a material for the buffer layer 20, silicon-based resin, fluorine-based resin, and acrylic-based resin may be used.

A diameter L of the spacer 30 is larger than an inner diameter L1 of the buffer layer 20 and smaller than an outer diameter L2 of the buffer layer 20. A material for the spacer 30 may be a material that is not cut by later-discussed blades of a remover, and a metallic wire such as copper and tungsten may be used. Furthermore, the material may be a material formed of KEVLAR (registered trademark) formed of aramid fibers or carbon fibers or a fiber-glass reinforced plastic (FRP) wire formed of glass fibers.

A material for the cover part 40 is a general ultraviolet curable resin. However, a thermoplastic resin may be used, and the material is not limited in particular if it is cut by the blades of the remover.

A cover of the ribbon tip needs to be removed with the remover and the like when the plastic fiber ribbon 100 according to the present embodiment is attached to a connector or a ferrule.

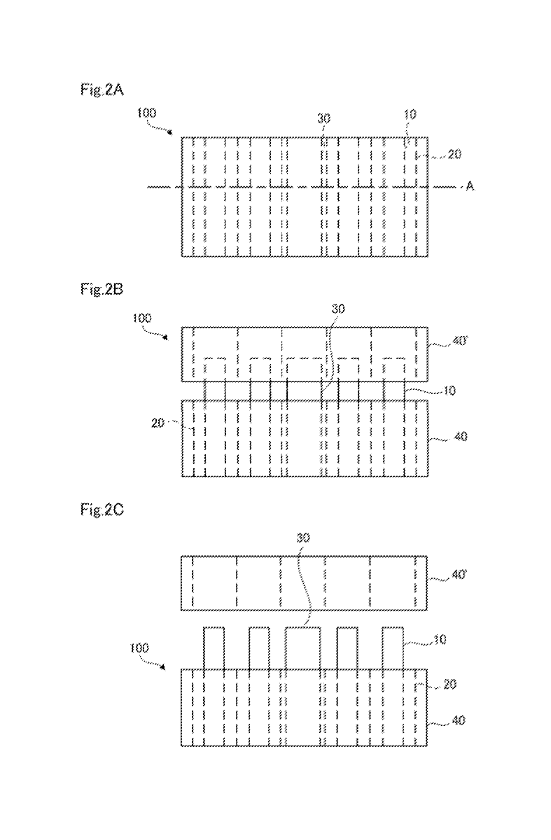

In the present embodiment, at first, the plastic fiber ribbon 100 is disposed on a fiber holder (not shown), and the holder is disposed on the remover (not shown). Next, as illustrated in FIG. 2(a), the blades of the remover contact the plastic fiber ribbon 100 at a cover removal position A, and dig into the cover part 40 and the buffer layers 20. At this time, the blades of the remover do not reach the plastic fibers 10.

Next, as illustrated in FIG. 2(b), by moving the remover to the tip side, a cover part 40′ on the tip side is separated from the cover part 40 on its proximal end side. At this time, the buffer layers 20 on the tip side and its proximal end side are also separated in the same manner. In addition, heat is applied to the plastic fiber ribbon 100 as needed.

Next, by further moving the remover, as illustrated in FIG. 2(c), the plastic fibers 10 are exposed in the tip part of the plastic fiber ribbon 100.

As described above, in the plastic fiber ribbon 100 of the present embodiment, cover removal is performed using a conventionally used remover in the same manner as a conventional method.

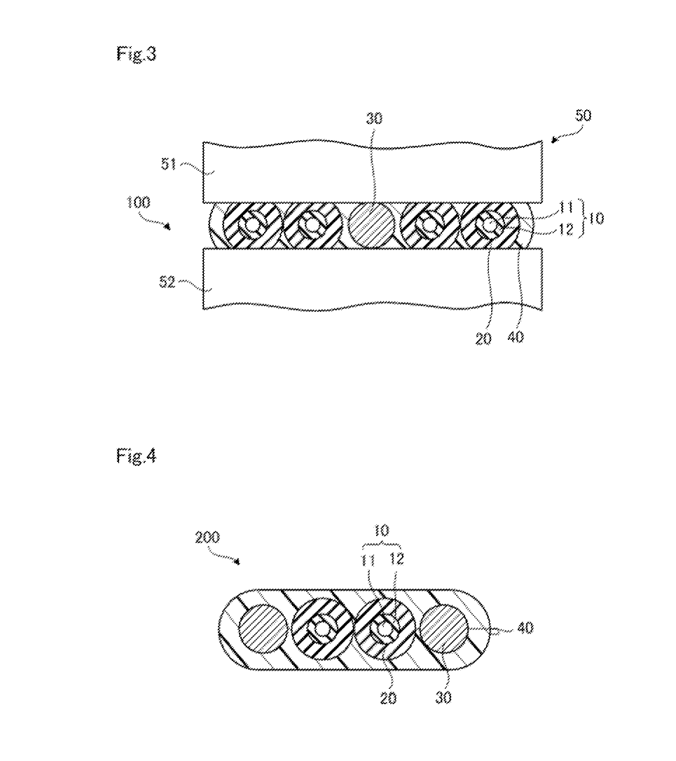

FIG. 3 illustrates a step illustrated in FIG. 2(a), and is a schematic sectional view of a case in which blades 51 and 52 of the remover 50 dig into the cover part 40 during removal of the cover part 40 of the plastic fiber ribbon 100 with the remover.

As explained above, by setting the diameter L of the spacer 30 larger than that of the plastic fiber 10, the blades 51 and 52 of the remover 50 do not dig into the plastic fiber 10 by the spacer 30. In addition, by setting the diameter L of the spacer 30 to be larger than the inner diameter L1 of the buffer layer 20 and smaller than the outer diameter L2 of the buffer layer 20, it is surely possible to dig the blades 51 and 52 of the remover 50 into the cover part 40. As described above, by setting the diameter L of the spacer 30 to be larger than the inner diameter of the buffer layer 20 and smaller than the outer diameter of the buffer layer 20, it is possible to cut the cover part 40 without damaging or cutting the plastic fiber 10. In addition, it is possible to remove the cover part 40 with a low tensile force.

Note that, in the case when a part of the buffer layers 20 remains on the circumferences of the plastic fibers 10 in removing the cover part 40, it is possible to wipe the remains out with a piece of cloth saturated with alcohol or the like is possible since the buffer layer 20 is silicon-based resin, fluorine-based resin, or acrylic-based resin.

Here, further detailed description is given regarding the relationship among the diameter L of the spacer 30, the inner diameter L1 and the outer diameter L2 of the buffer layer 20. As illustrated in FIG. 3, the blades 51 and 52 of the remover 50 do not dig into the plastic fibers 10 by the spacer 30. However, in the case when the diameter L of the spacer 30 is extremely large in comparison with the diameter of the plastic fiber 10, an interval between the blades 51 and 52 of the remover 50 widen in response to this. As a result, a dig amount of the blades 51 and 52 of the remover 50 into the cover part 40 reduces. Thereby, while the tensile force to cut the cover part 40 increases during removal of the cover part 40 with the remover 50, an excessive force is added to the plastic fiber 10. Thereby, the plastic fiber 10 stretches. In some cases, the plastic fiber 10 is cut.

For the reasons described above, the blades 51 and 52 of the remover 50 during removal of the cover part 40 preferably cut the cover part 40 to the extent possible. A maximum cut amount of the cover part 40 with the blades 51 and 52 of the remover 50 without cutting the plastic fibers 10 is determined based on positional variation of the plastic fibers 10 in a cut direction since the interval between the blades 51 and 52 of the remover 50 is determined by the spacer 30.

The positional variation differs in accordance with the number of plastic fibers 10. The positional variation is approximately ±5 μm. That is, by increasing the diameter of the spacer 30 than that of the plastic fiber 10 by 10 μm, the cover part 40 is cut at a maximum, and removal of the cover part 40 without cutting the plastic fibers 10 becomes possible. When the positional variation of the plastic fibers 10 is smaller than the above-described value, the diameter of the spacer 30 can be smaller than the above-described value. On the other hand, when the positional variation of the plastic fibers 10 is larger than the above-described value, the diameter of the spacer 30 may be larger than the above-described value. However, the cut amount of the cover part 40 with the blades 51 and 52 of the remover 50 becomes smaller, and there is a possibility that stretch and/or cut of the plastic fibers 10 is generated during cover removal.

The plastic fiber ribbon 100 in which the four plastic fibers 10 with a 125 μm diameter, the spacer 30 with a 135 μm diameter, and the cover part 40 with a 350 μm thickness were formed in the arrangement illustrated in FIG. 1 was used, and cover removal of the ribbon 100 was performed using a remover (Hot Jacket Remover JR-6 for ribbon fiber by Sumitomo Electric Industries, Ltd). As a result, it was possible to remove the cover part 40 without generation of stretch or cut in all of the plastic fibers 10.

Meanwhile, in the case of a plastic fiber ribbon in which the spacer 30 was not used, stretch was generated in parts of the plastic fibers 10. Note that the spacer 30 is arranged to determine the interval between the blades 51 and 52 of the remover 50 and is also simultaneously used as a reinforcement member of the plastic fiber ribbon other than for the determination of the interval.

As described above, according to the present embodiment, by arranging the spacer 30 in parallel with the plastic fibers 10, and appropriately setting the diameter L of the spacer 30 (L1<L<L2), it is possible to suppress stretch and cut of the plastic fibers 10 during cover removal. Accordingly, the reliability of the plastic fiber ribbon 100 is improved, and the industrial value thereof is extremely high.

### Second Embodiment

FIG. 4 is a sectional view of a schematic configuration of a plastic fiber ribbon 200 according to a second embodiment.

A different point of the present embodiment from that of the first embodiment explained above is that a plurality of the spacers 30 is used rather than one. More specifically, the respective spacers 30 are arranged on both sides of the alignment of the plastic fibers 10 rather than the center of the alignment of the plurality of the plastic fibers 10.

The configuration other than the arrangement position of the spacer 30 is the same as the first embodiment. That is, the materials of the plastic fibers 10, the buffer layers 20, the spacers 30, and the cover part 40 are the same as those of the first embodiment. Furthermore, the diameter L of the spacer 30 is set within the range L1<L<L2 in the same manner as the first embodiment.

By configuring as described above, the effects similar to those of the above first embodiment are obviously obtained, and effects discussed below are obtained.

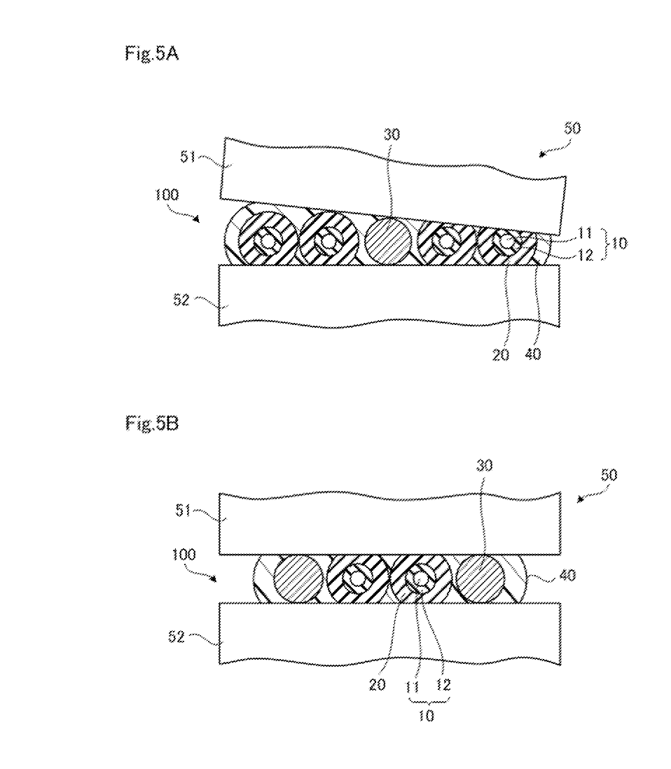

As illustrated in FIG. 5(a), in the case when there is looseness between the blades 51 and 52 of the remover 50, there is a possibility for the blades 51 and 52 of the remover 50 to enter into the plastic fibers 10 in the plastic fiber ribbon 100 according to the first embodiment. This causes damage of the plastic fibers 10.

On the other hand, in the plastic fiber ribbon 200 of the present embodiment, as illustrated in FIG. 5(b), it is surely possible to make the blades 51 and 52 of the remover 50 be parallel with the two spacers 30, and to suppress entering of the blades 51 and 52 of the remover 50 into the plastic fibers 10.

In addition, in the case of the plastic fiber ribbon 200 of the present embodiment, by putting the two spacers 30, an effect as reinforcement members is improved in comparison with the plastic fiber ribbon 100 configured by one spacer 30, and usage of the spacers 30 as a power source line or an electric signal line becomes possible.

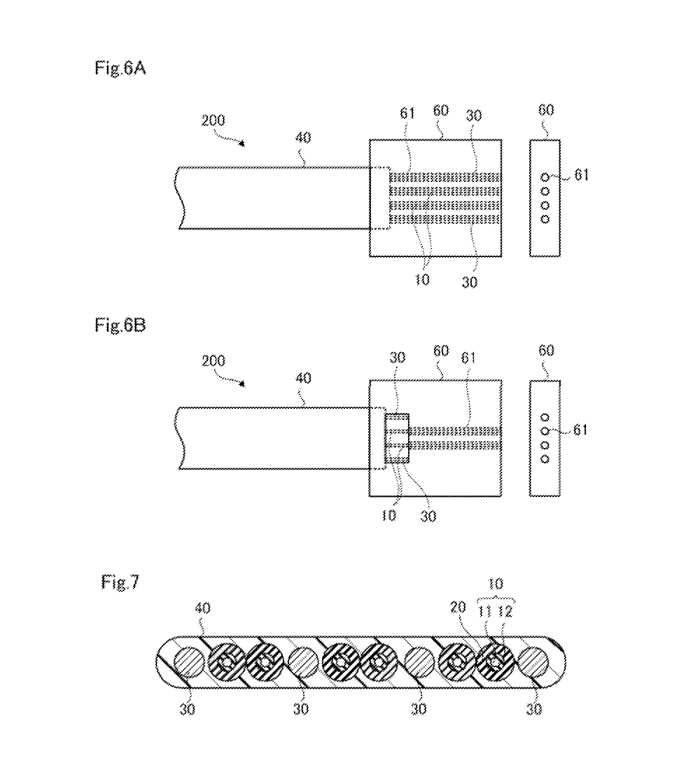

In addition, as illustrated in FIG. 6(a), in the case when the plastic fiber ribbon 200 is installed to a ferrule 60, the spacers 30 are inserted into and fixed to hold holes 61 that hold the plastic fibers 10. Thereby, in the case when a tension is applied to the plastic fiber ribbon 200, the spacers 30 may also perform as tensile strength members.

Furthermore, as illustrated in FIG. 6(b), by previously defining positions of tips of the plastic fibers 10 and tips of the spacers 30 and abutting the tips of the spacers 30 on a predetermined position in the ferrule 60, it is possible to determine the tip position of the plastic fibers 10 to be at a predetermined place in the hold holes 61.

As described above, in the case when the plastic fiber ribbon 200 is installed to the ferrule 60, the plastic fibers 10 and the spacers 30 are preferably arranged at even intervals since the hold holes 61 of the ferrule 60 are arranged at even intervals.

Note that the number of the spacer 30 does not need to be limited to 1 or 2. By arranging, for example, the three or more spacers 30 as illustrated in FIG. 7, a contact area with the blades 51 and 52 of the remover 50 increases. Thereby, suppression of frequency of damage of the spacers 30 by the blades 51 and 52 of the remover 50 becomes possible. In addition, there is an advantage that the plastic fibers 10 are easily separated from each other.

### Third Embodiment

FIGS. 8(a) and (b) are sectional views of a schematic configuration of a plastic fiber ribbon 300 according to the third embodiment.

A different point of the present embodiment from that of the above first embodiment is that a photo foam material that foams by being irradiated with light is used as buffer layers 21.

As illustrated in FIG. 8(a), the plastic fiber ribbon 300 of the present embodiment is configured from the plastic fibers 10 including the core 11 and the cladding 12, the buffer layers 21, the spacers 30, and a cover part 40.

As a specific configuration, the buffer layer 21 is coaxially formed to cover the circumference of the plastic fiber 10, and the plurality of plastic fibers 10 with the buffer layer 21 on the outer circumference thereof are arranged in parallel. Furthermore, the spacers 30 are arranged on both sides of the alignment of the plastic fibers 10 in parallel. Then, these are covered by the cover part 40.

The buffer layer 21 is configured by a material including the photo foam material that foams by being irradiated with light. As the material of the buffer layer 21, a base material in which azo compound-based agent is added to silicon-based resin is used. Note that, as the base material, epoxy-based resin, urethane-based resin, and polyester-based resin may also be used. Furthermore, as a foam agent, diazo compound-based and dinitro compound-based materials may also be used. Light radiated on the buffer layers 21 preferably has a wavelength in the ultraviolet region to increase a foam reaction rate.

The spacer 30 includes the same materials as the first embodiment, and the diameter L thereof is larger than the inner diameter L1 of the buffer layer 21 and smaller than the outer diameter L2 of the buffer layer 21 in the same manner as the first and second embodiments.

The material of the cover part 40 is a general ultraviolet curable resin. However, thermoplastic resin may be used, and the material is not limited in particular if it is cut by the blades of the remover. Note that the agent may be added to the cover part 40 in the same manner as the buffer layer 21. In addition, there may be a configuration in which a light shield member is coated on the outer circumference of the cover part 40 and a light shield member is separately removed only from a portion with which light is irradiated.

In such a configuration, by radiating light to a region of the cover part 40 of the plastic fiber ribbon 300 to be removed, foam 22 is generated in the buffer layers 21 in the region as illustrated in FIG. 8(b). By the foam 22 generated in the buffer layers 21, a contact area between the buffer layer 21 and the plastic fiber 10 decreases, and as a result, adherence decreases. Therefore, during removal of the cover part 40, a tensile force applied to the plastic fiber 10 by the buffer layer 21 decreases, and it is possible to suppress stretch of the plastic fibers 10 during cover removal.

Removal of the cover part 40 of the plastic fiber ribbon 300 with such a configuration is performed with the remover in the same manner as the first and second embodiments. That is, light is radiated on a place of the cover part 40 to be removed. The remover widely used for cover removal of the plastic fiber ribbon 300 is used. As illustrated in FIG. 3, the blades 51 and 52 of the remover 50 dig into the buffer layers 21. Then, by pulling out the cover part 40 in a longitudinal direction of the plastic fiber ribbon 300, the tip part of the cover part 40 of the plastic fiber ribbon 300 is removed.

As described above, according to the present embodiment, by selecting the photo foam material as the buffer layer 21 that surrounds the plastic fiber 10, it is possible to further decrease the adherence of the buffer layer 21 to the plastic fiber 10 in the cover removal region. Accordingly, the effects similar to those of the first embodiment are obviously obtained. It is possible to certainly suppress stretch and cut of the plastic fibers 10 during cover removal.

Note that, as the buffer layer 21, a thermo foam material may be used as an alternative for the photo foam material. In the case when the thermo foam material is used, as a base material, for example, epoxy-based resin, urethane-based resin, and polyester-based resin may be selected. Furthermore, as an agent, materials such as halogenation fluorine compound, azo compound, and hydrazine compound materials, and the like may be selected.

By applying heat to the buffer layers 21 including such materials, the foam 22 is generated in the buffer layer 21, the contact area between the buffer layer 21 and the plastic fiber 10 decreases, and the adherence to the plastic fiber 10 decreases. As a result, the tensile force of the plastic fiber 10 during removal of the cover part 40 decreases, and it becomes possible to suppress stretch of the plastic fibers 10.

Note that a temperature of the heat applied to the buffer layers 21 is preferably a heatproof temperature of the plastic fibers 10 or less.

### Fourth Embodiment

FIGS. 9(a) and (b) are sectional views of a schematic configuration of a plastic fiber ribbon 400 according to a fourth embodiment.

A different point of the present embodiment from that of the above first embodiment is that a photo strip material of which adherence force decreases by light radiation is used as the buffer layers 23. That is, as illustrated in FIG. 9(a), in the plastic fiber ribbon 400 according to the present embodiment, the buffer layer 23 is formed of the photo strip material, and the configuration other than the buffer layers 23 is the same as the third embodiment.

For a material of the buffer layer 23 according to the present embodiment, as a base material, acrylic-based resin, silicone-based resin may be selected, and as a photo polymerization material, oligomer such as acrylic-based oligomer, urethane-based oligomer, and silicon-based oligomer may be selected. Furthermore, as a photoinitiator, alkylacetophenone-based, acrylphosphine oxide-based, and titanocene-based materials may be selected.

In addition, light radiated on the buffer layers 23 preferably has a wavelength in the ultraviolet region to increase a strip reaction rate.

In such a configuration, by light radiated on a region of the cover part 40 of the plastic fiber ribbon 400 to be removed, as illustrated in FIG. 9(b), the strip is generated on an interface 71 between the buffer layer 23 and the plastic fiber 10 in the region, and adherence of the buffer layer 23 to the plastic fiber 10 decreases. Furthermore, the strip is generated on an interface 72 between the buffer layer 23 and the cover part 40, and adherence of the buffer layer 23 to the cover part 40 decreases. As a result, during removal of the cover part 40, tensile force of the plastic fiber 10 decreases, and suppression of stretch of the plastic fibers 10 becomes possible.

As described above, according to the present embodiment, by selecting the photo strip material as the buffer layer 23 that surrounds the plastic fiber 10, it is possible to further decrease the adherence of the buffer layers 23 to the plastic fibers 10 in the cover removal region. Accordingly, the effects similar to those of the first embodiment are obviously obtained. It is possible to certainly suppress stretch and cut of the plastic fibers 10 during cover removal.

Note that, as the buffer layer 23, a thermo-strip material may be used as an alternative for the photo strip material. In the case when the thermo-strip material is used, as a base material, for example, acrylic-based resin, vinyl-based resin, silicon-based resin, urethane-based resin and the like may be selected. Furthermore, as a thermo-strip material, a thermo-expandable particle in which propane or pentane is included in a vinyl-based resin or an acrylic-based resin shell may be selected.

By applying heat to the buffer layers 23 including such materials, the adherence of the buffer layer 23 to the plastic fiber 10 decreases, and the adherence of the buffer layer 23 to the cover part 40 also decreases. As a result, the tensile force of the plastic fiber(s) 10 during removal of the cover part 40 decreases, and it is possible to suppress stretch of the plastic fibers 10.

Note that a temperature of the heat applied to the buffer layers 23 is preferably the heatproof temperature of the plastic fibers 10 or less.

### Fifth Embodiment

FIG. 10 is a sectional view of a schematic configuration of a plastic fiber ribbon 500 according to the fifth embodiment.

The plastic fiber ribbon 500 according to the present embodiment is configured from the plastic fibers 10 including the core 11 and the cladding 12, buffer layers 25, the spacers 30, and the cover part 40.

As a specific configuration, the buffer layer 25 is formed to surround the outer circumference of the plastic fiber 10, and the plurality of plastic fibers 10 with the buffer layer 25 on the outer circumference thereof are arranged in parallel. Moreover, the spacers 30 are arranged in parallel on both sides of the parallel alignment of the plastic fibers 10. Then, these are covered by the cover part 40.

Here, the buffer layer 25 is formed to arrange the plastic fibers 10 at the same predetermined interval. Note that Young's modulus of the buffer layer 25 is made smaller than that of the cover part 40, and the buffer layer 25 may be used as a buffer member of the plastic fiber 10.

The buffer layer 25 of the present embodiment is formed by a material that is dissolvable to organic solvent. As the material of the buffer layer 25, acrylic-based, urethane-based, silicon-based, polyester-based and epoxy-based ultraviolet curable resins may be used. A-1190 (Tesk Co., Ltd.) and UV-7605B (Nippon Synthetic Chemical Industry Co., Ltd.) dissolved in alcohol, and A-1840 (Tesk Co., Ltd.) and the like dissolved in organic solvent except for alcohol-based organic solvent may be used, for example.

In the present embodiment, in the case when the buffer layers 25 and the cover part 40 on the tip end of the plastic fiber ribbons 10 are removed at a cover removal position A of the plastic fiber ribbon 500, a removal region B thereof is dipped in the organic solvent. That is, the tip part is immersed in the organic solvent to the cover removal position A. Thereby, as illustrated in FIG. 11(a), the buffer layers 25 of the ribbon tip part are removed.

Next, by contacting the cover part 40 with the blades of the remover at the cover removal position A and pulling the cover part 40, as illustrated in FIG. 11(b), the plastic fibers 10 of the tip part are exposed. At this time, the plastic fibers 10 are not pulled during removing of the cover part 40 since the buffer layers 25 of the tip part are already removed.

After the cover part 40 is removed, the organic solvent is wiped off the exposed plastic fibers 10 with a piece of non-woven fabric and the like, and residues such as the cover part 40 and/or the buffer layers 25 simultaneously are wiped off. The exposed plastic fibers 10 may be dipped in water and washed as needed.

The organic solvent is preferably ethanol from the point of view of treatment. However, solution such as acetone, isoprophl alcohol, methanol, toluene, thinner and the like may be used, and these are arbitrarily selected in accordance with the materials of the buffer layer 25 and the cover part 40.

As described above, according to the present embodiment, by using a material as the buffer layer 25, which is dissolvable to the organic solvent, the buffer layers 25 of the ribbon tip end are removed without using remover and the like. Therefore, the cover part 40 is only cut with the remover during cover removal. Cut, stretch, and damage of the plastic fibers 10 during cover removal are prevented. In addition, since the buffer layers 25 are removed with the organic solvent, the diameter L of the spacer 30 may be larger than the diameter of the plastic fiber 10, and there is also an advantage that a freedom degree of selection of the spacer 30 increases.

Note that the plastic fiber 10 is a graded index optical fiber formed of a fluorine-based resin, for example, and the material thereof may be made of PMMA resin and polycarbonate resin, and for the organic solvent that dissolves the buffer layer 25, only organic solvent that do not dissolves the material of the plastic fiber 10 used may be selected.

In addition, not only as a material for the buffer layer 25 but also as a material of the cover part 40, a material that dissolves with organic solvent may be selected. In this case, since the buffer layers 25 and the cover part 40 in the cover removal parts are removed by dipping the part with the organic solvent, remove of the cover part 40 with the remover may be unnecessary.

In addition, as a material for the buffer layer 25 and the cover part 40, materials dissolved in water may be used. As a material of the buffer layer 25, polyvinyl alcohol-based ultraviolet curable resin may be used. As ultraviolet curable resin dissolved in water, A-1446 and A-1594 (Tesk Co., Ltd.) may be used, for example. In this case, there is an advantage that the buffer layers 25 are removed with harmless solution for humans.

### Sixth Embodiment

FIG. 12(a) is a sectional view of a schematic configuration of a plastic fiber ribbon 600 according to the sixth embodiment. FIG. 12(b) is a top plan view of the schematic configuration of the plastic fiber ribbon 600 according to the sixth embodiment.

A different point of the present embodiment from that of the above fifth embodiment is that materials of a cover part 45 as well as the buffer layer 25 are dissolvable to organic solvent. Furthermore, the entire buffer layer 25 and the entire cover part 45 are not formed by materials that are dissolvable to organic solvent, and have parts thereof are not dissolvable.

As a specific configuration, the buffer layer 25 is formed on the outer circumference of the plastic fiber 10, and the plurality of plastic fibers 10 with the buffer layer 25 on the outer circumference thereof are arranged in parallel. Furthermore, the spacers 30 are arranged on both sides of the parallel alignment of the plastic fibers 10 in parallel. Then, these are covered by the cover part 45.

The materials of the buffer layer 25 and the cover part 45 are basically materials that easily dissolve with organic solvent as those used in fifth embodiment, and parts thereof are formed of hardly-soluble materials. That is, the buffer layer 25 and the cover part 45 are not formed by the same material along an axial direction of the plastic fiber 10. They are formed by hardly-soluble materials arranged at a certain interval along the axial direction. More specifically, parts C that easily dissolve and parts D that hardly dissolve are alternately arranged in the buffer layer 25 and the cover part 45 along the axial direction of the plastic fiber 10.

FIGS. 13(a)-(c) are top plan views of removal steps of a plastic fiber ribbon 600.

In such a configuration, as illustrated in FIG. 13(a), a cover removal region B of the plastic fiber ribbon 600 is dipped in the organic solution. At this time, the cover removal position A of the plastic fiber ribbon 600 is set within a range in the part D that hardly dissolve of the buffer layers 25 and the cover part 45.

Thereby, as illustrated in FIG. 13(b), in the removal region B, the parts C that easily dissolve of the buffer layers 25 and the cover part 45 are removed, and the part D that hardly dissolve thereof are not removed and remains. That is, of the respective parts C and D of the buffer layers 25 and the cover part 45, only the parts C positioned in the removal region B are removed. Then, the part D in the removal region B and the buffer layers 25 and the cover part 45 except for the removal region B remain.

Next, as illustrated in FIG. 13(c), by sliding off the buffer layers 25 and the cover part 45 that remain in the removal region B from the tip end side of the plastic fibers 10, the plastic fibers 10 are exposed. After dipping, in the same manner as the above fifth embodiment, the organic solution is wiped off with a piece of non-woven fabric or the like, and residues such as the cover part 40 and/or the buffer layers 25 are simultaneously wiped off.

As described above, according to the present embodiment, by making the hardly-soluble regions D formed with a hardly-soluble material as parts of the buffer layers 25 and the cover part 45, the region D functions as a dissolution stop layer. Accordingly, even if there is fluctuation in the removal region B, precisely determination of a removal position of the buffer layers 25 and the cover part 45 is possible.

Note that the hardly-soluble region D are removed by remover, wipe and the like after dissolution of the buffer layers 25 and the cover part 45, and a width of the hardly-soluble region D is set to be easily removed for these treatments.

In addition, in the same manner as the fifth embodiment, as materials for the buffer layer 25 and the cover part 40, materials dissolved in water may be used.

In addition, since both of the buffer layers 25 and the cover part 40 in the cover removal region B are removed, the remover for cutting these becomes unnecessary. Accordingly, the diameter of the spacers 30 may freely be set regardless of the inner diameter and outer diameter of the buffer layer 25.

### MODIFICATION

Note that the present disclosure is not limited to the above-described embodiments.

The alignment number of the plastic fibers and the arrangement number of the spacers are not necessarily limited to the numbers explained in the embodiments, and are arbitrarily variable according to specifications. Furthermore, one plastic fiber and one spacer may be applied.

Materials of the buffer layer and the cover part are not necessarily limited to the materials explained in the embodiments, and are arbitrarily variable according to specifications.

The diameter L of the spacer is preferably within the range of L1<L<L2 in the case when the buffer layers and the cover part are incised as the first to fourth embodiments. However, in the case when the buffer layers are removed as fifth and sixth embodiments, the diameter L may be equal to the diameter of the plastic fiber or more. Materials of the spacer are not limited to the materials explained in the embodiments, and are arbitrarily variable.

As the fifth and sixth embodiments, in the case when the buffer layer as well as the cover part formed by a material that is dissolvable to organic solution or water, the spacers are not necessary and may be omitted.

While certain embodiments have been described, these embodiments have been presented by way of example only; and are not intended to limit the scope of the inventions. Indeed, the novel embodiments described herein may be embodied in a variety of other forms; furthermore, various omissions, substitutions and changes in the form of the ribbons and methods described herein may be made without departing from the spirit of the inventions. The accompanying claims and their equivalents are intended to cover such forms or modifications as would fall within the scope and spirits of the inventions.

What is claimed is:

1. A plastic fiber ribbon, comprising:
a plastic fiber having an outer diameter L1;
a buffer layer formed to surround an outer circumference of the plastic fiber and having an inner diameter L1 and an outer diameter L2;
a spacer positioned adjacent to the plastic fiber; and
a covering over the plastic fiber, the buffer layer, and the spacer, wherein
a diameter L of the spacer is set to be larger than an inner diameter L1 of the buffer layer and smaller than an outer diameter L2 of the buffer layer.

2. The plastic fiber ribbon according to claim 1, wherein
the buffer layer is formed of a material having lower Young's modulus than that of the covering and a lower adherence to the plastic fiber than to covering.

3. The plastic fiber ribbon according to claim 1, wherein
at least a portion of the buffer layer forms a foam having voids therein upon the exposure of the buffer layer to light or heat.

4. The plastic fiber ribbon according to claim 1, wherein
the buffer layer is formed of a material of which adherence of the buffer layer to the plastic fiber is decreased by the irradiation of the covering with light or by the application of heat to the covering.

5. The plastic fiber ribbon according to claim 1, wherein
the plastic fiber and the covering are formed of a material that is not dissolvable in a predetermined organic solution or water, and the buffer layer is formed of a material that is dissolvable in the organic solution or water.

6. The plastic fiber ribbon according to claim 1, wherein
the plastic fiber includes a plurality of plastic fibers arranged generally side by side along their length, and a spacer is positioned at least one either side of the plurality of plastic fibers.

7. The plastic fiber ribbon of claim 6, wherein the plurality of fibers are generally circular in cross section, and the centers of the fibers are arranged along a straight line path such that the centers deviate from the straight line path by a distance equal to or less than a tolerance T; and
the minimum diameter of the spacer is L1 plus T.

8. The plastic fiber ribbon of claim 7, wherein the plastic fiber includes a plastic core surrounded by a cladding.

9. A plastic fiber ribbon, comprising:
a plastic fiber having an outer diameter L1;
a buffer layer formed to surround an outer circumference of the plastic fiber, the buffer layer being convertible upon the application of a secondary action thereto; and
a covering over the plastic fiber, the buffer layer, and the spacer, wherein
upon the application of a secondary action to the plastic fiber ribbon; the physical composition of the plastic fiber ribbon is changed.

10. The plastic fiber ribbon of claim 9, wherein the secondary action is the application of heat or light to the plastic fiber ribbon.

11. The plastic fiber ribbon of claim 9, wherein the secondary action is the exposure of the plastic fiber ribbon to a solvent which dissolves the buffer layer.

12. A method of exposing a length of plastic fiber from a terminus of a plastic fiber ribbon, comprising:
providing a plastic fiber having an outer diameter L1;
providing a buffer layer formed to surround an outer circumference of the plastic fiber and having an inner diameter L1 and an outer diameter L2;
providing at least one spacer positioned adjacent to the plastic fiber; and
providing a covering over the plastic fiber, the buffer layer, and the spacer, wherein
a diameter L of the spacer is set to be larger than an inner diameter L1 of the buffer layer and smaller than an outer diameter L2 of the buffer layer;
positioning the plastic fiber ribbon between two substantially parallel blades at a location on the ribbon from which the plastic fiber is to be exposed and extending the blades into the covering layer and at least a portion of the buffer layer and contacting the blades with the spacer; and
removing the covering and buffer layer extending over the plastic fiber to be exposed.

13. The method of claim 12, wherein the step of removing the covering includes moving the blades, extending into the covering and buffer layer, in the direction of the end of the plastic fibers to be exposed.

14. The method of claim 12, wherein the step of removing the covering includes the step of pulling the portion of the covering overlaying the plastic fiber from the plastic fiber to be exposed.

15. The method of claim 12, wherein the plastic fiber ribbon includes a plurality of plastic fibers arranged adjacent to one another wherein the centers of the adjacent fibers are arranged along a straight line path with no more than a tolerance length deviation from the straight line path.

16. The method of claim 15, wherein the spacer is located between two fibers.

17. The method of claim 15, wherein a spacer is located to either side of a plurality of fibers.

18. The method of claim 16, further including a spacer is located to either side of a plurality of fibers.

19. The method of claim 18, wherein the change agent is light or heat.

20. The method of claim 18, wherein the change agent is a solvent which dissolves at least a portion of the buffer material in the region where the plastic fiber is to be exposed.
